(19) United States
(12) Patent Application Publication
(10) Pub. No.: US 2008/0120426 A1
(43) Pub. Date: May 22, 2008

(54) SELECTIVE ACCELERATION OF TRANSPORT CONTROL PROTOCOL (TCP) CONNECTIONS

(75) Inventors: Ganesh Balakrishnan, Morrisville, NC (US); Jorge R. Rodriguez, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/561,067

(22) Filed: Nov. 17, 2006

(51) Int. Cl. G06F 15/163

(52) U.S. Cl. 709/230

(57) ABSTRACT

Embodiments of the present invention address deficiencies of the art in respect to TCP processing and provide a novel and non-obvious method, system and computer program product for selectively accelerating TCP connections. In one embodiment of the invention, a method of selectively accelerating TCP connections in TCP/IP based inter-process communications can be provided. The method can include establishing a TCP connection for TCP/IP inter-process communications, observing a block size for the TCP connection, and switching between TCP/IP processing in a host processor and TCP/IP processing in a TOE in a network adapter coupled to the host processor based upon the observed block size exceeding a threshold value.

### BACKGROUND OF THE INVENTION

1. Field of the Invention

The present invention relates to the field of inter-process and intra-process communications and more particularly to the management of transport control protocol (TCP) sessions in inter-process and intra-process communications.

2. Description of the Related Art

Inter-process and intra-process communications relates to the exchange of electronic data between two or more computing processes, or within a single computing process, in a computer communications network. Traditionally, inter-process and intra-process communications in the context of the Internet protocol (IP) involves the addressing of information for delivery to a computing process at a specific network address using a specific port therein. In this regard, the combination of the address and port, referred to as a socket, can form the basis of sockets based communications.

TCP/IP communications represents the most prevalent of network protocols utilized for inter-process and intra-process communications. Typically, TCP/IP is implemented as part of the operating system in a host computing platform and provides network communications services through service calls to the TCP/IP “stack”. Specifically, as application data is processed in the TCP/IP stack, the data is transformed into packets for transmission over the network medium through the operation of a network interface card (NIC) for the host computing platform. Consequently, the entirety of the TCP/IP processing occurs in the host computing platform.

TCP/IP communications is known to be computing intensive, especially when transmitting very large blocks of data. To address the intense computing resource consumption of TCP/IP, occasionally, TCP/IP process can be offloaded from the host computing platform to a coupled NIC. The NIC can be specially configured to support the TCP/IP stack in order to relieve the host computing platform from TCP/IP processing. In the art, a specially configured NIC to handle TCP/IP processing on board has been referred to as a TCP/IP Offload Engines (TOE). In most TOE implementations, the underlying NIC can operate in TOE mode, or in standard NIC mode.

The use of a TOE to process TCP/IP transactions in lieu of a TCP/IP stack within a host computing platform acts to reduce central processing unit (CPU) utilization in the host computing platform. Yet, the performance of the TOE lags that of the TCP/IP stack of the host computing platform. Therefore, the use of the TCP/IP stack in the host computing platform scales best whereas scalability suffers in the use of the TOE. Accordingly, the choice of deploying a TOE in lieu of a TCP/IP stack within a host computing system depends largely upon the context of use of TCP/IP processing. The process of applying a particular choice, one way or the other, can burden the network management staff with the responsibility of repeatedly changing the proper configuration for TCP/IP processing responsive to changes in context.

### BRIEF SUMMARY OF THE INVENTION

Embodiments of the present invention address deficiencies of the art in respect to TCP processing and provide a novel and non-obvious method, system and computer program product for selectively accelerating TCP connections. In one embodiment of the invention, a method of selectively accelerating TCP connections in TCP/IP based inter-process communications can be provided. The method can include establishing a TCP connection for TCP/IP inter-process communications, observing a block size for the TCP connection, and switching between TCP/IP processing in a host processor and TCP/IP processing in a TOE in a network adapter coupled to the host processor based upon the observed block size exceeding a threshold value.

In one aspect of the embodiment, observing a block size for the TCP connection can include measuring an average block size for the TCP connection of a particular interval of time. In another aspect of the embodiment, the method further can include adjusting the interval of time to account for latencies associated with moving connection state data between the host processor and the network adapter during switching. In yet another aspect of the embodiment, switching between TCP/IP processing in a host processor and TCP/IP processing in a TOE in a network adapter can include switching from TCP/IP processing in a host processor to TCP/IP processing in a TOE when the observed block size exceeds a threshold value. Conversely, when the observed block size falls below a threshold value, the method can include switching from TCP/IP processing in a TOE to TCP/IP processing in a host processor.

In another embodiment of the invention, a TCP/IP based inter-process communications data processing system can be provided. The system can include a host processor disposed in a host computing platform and a network adapter coupled to the host computing platform. The network adapter can be a NIC and can include a TOE. Notably, a shim layer can be disposed in the host processor. The shim layer can include program code enabled to observe a block size for a supported TCP connection and switch between TCP/IP processing in the host processor and TCP/IP processing in the TOE based upon the observed block size exceeding a threshold value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a TCP connection processing data processing system configured for selective acceleration of TCP connections; and,

FIG. 2 is a flow chart illustrating a process for selectively accelerating TCP connections.

### DETAILED DESCRIPTION OF THE INVENTION

Embodiments of the present invention provide a method, system and computer program product for the selective acceleration of TCP connections. In accordance with an embodiment of the present invention, a host processor in a host computing platform can be configured for TCP processing. Likewise, a network adapter coupled to the host computing platform can be configured with a TOE. When the average block size for a TCP connection established with a TCP/IP stack in the host computing platform exceeds a threshold value, the TOE can be used to manage the TCP connection. Otherwise, when the average block size for the TCP connection falls below the threshold value, the TCP/IP stack in the host computing platform can be used to manage the TCP connection.

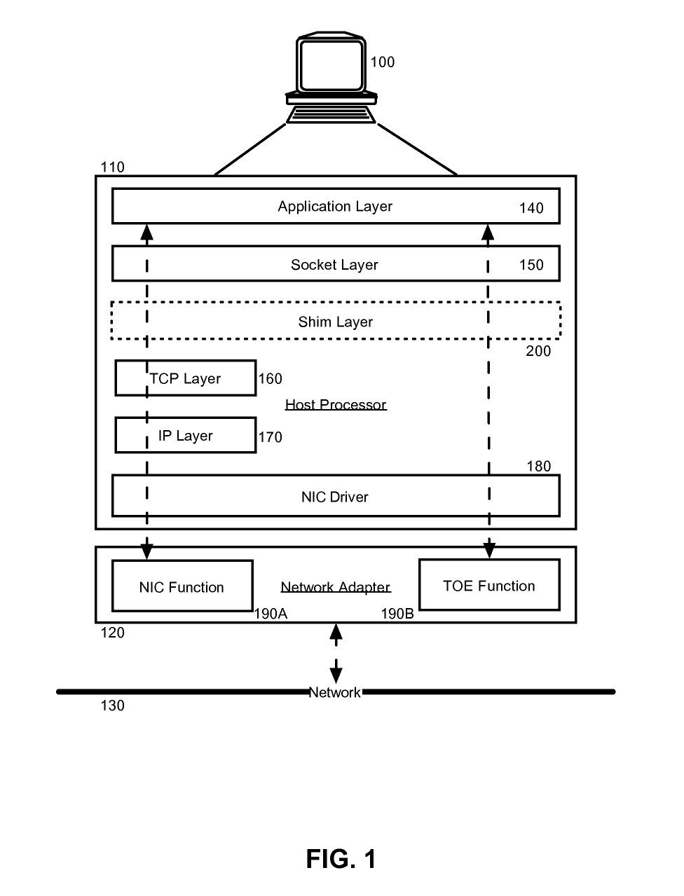

In further illustration, FIG. 1 is a schematic illustration of a TCP connection processing data processing system configured for selective acceleration of TCP connections. The system can include a host computing platform 100 providing a host processor 110. A network adapter 120 further can be coupled to the host computing platform 100, for example as a NIC, the network adapter 120 providing a configuration for coupling to a network infrastructure 130. The host processor 110 can include a computing architecture sufficient to support inter-process communications between applications operating in the host computing platform 100 and in other platforms communicatively coupled to the host computing platform over a computer communications network (not shown).

The computing architecture of the host processor 110 can include an application layer 140 coupled to a socket layer 150. The application layer 140 can provide a high level interface to inter-process communications services including the establishment and use one or more TCP connections. The socket layer 150 in turn can support the establishment and access to TCP connections on behalf of communicating applications. The host processor 110 also can include a TCP layer 160 configured to process TCP/IP communications according to TCP, and an IP layer 170 configured to process TCP/IP communications according to IP. Finally, a NIC driver 180 can be provided to directly interface with the coupled network adapter 120.

The NIC adapter 120 can be a hybrid adapter configured to support a TOE functions 190B and also conventional NIC functions 190A. A shim layer 200 disposed in the host processor 110 can include program code enabled to select from among the NIC functions 190A and TOE functions 190B based upon prevailing environmental conditions, including the observed block size for a TCP connection of interest. In this regard, where the observed block size of a TCP connection of interest exceeds a pre-determined threshold value, the TOE functions 190B can be selected in order to offload processing from the host processor 110. In contrast, where the observed block size of a TCP connection of interest falls below a pre-determined threshold value, the NIC functions 190A can be selected in the network adapter 120 in order to facilitate scalability for a TCP connection dominated by small blocks of data.

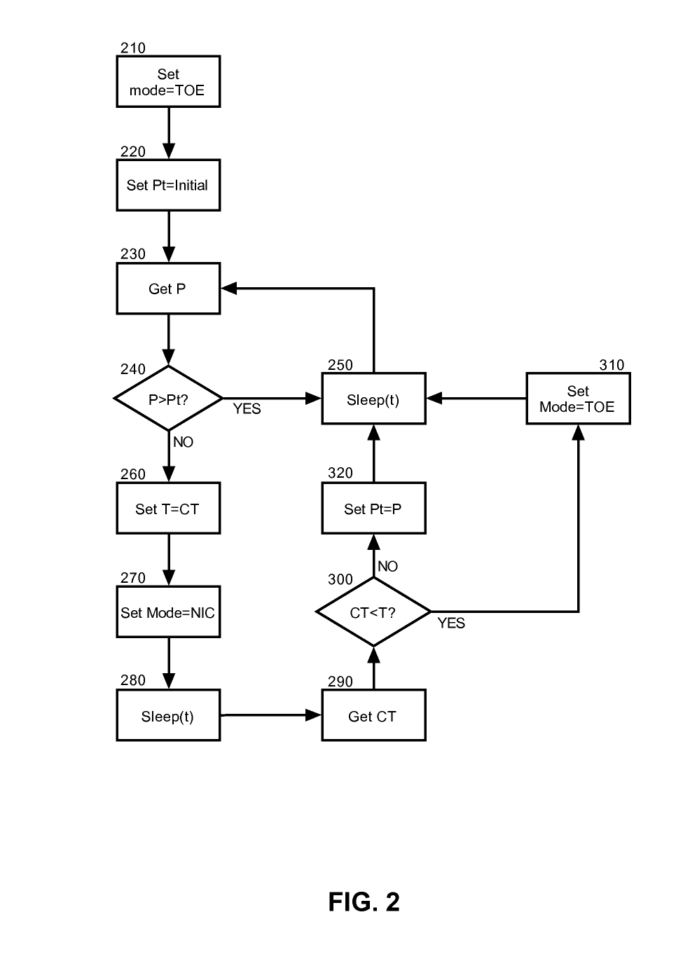

In yet further illustration of the operation of the shim layer 200, FIG. 2 is a flow chart illustrating a process for selectively accelerating TCP connections. Beginning in block 210, the initial TCP processing mode can be set to TOE in the network adapter. In block 220, an initial block size threshold can be established, for example at 1,024 bytes. Thereafter, in block 230 the average block size for a subject TCP connection can be observed for a time interval. In decision block 240, if the observed average block size for the interval can be compared to the threshold to determine whether the observed average block size exceeds the threshold value. If so, the TCP processing mode can remain at TOE and the next interval can proceed in block. Otherwise, the process can continue through block 260.

In block 260, if the observed average block size does not exceed the threshold value indicating a TCP connection dominated by smaller blocks, in block 260 the interval can be set to the currently observed throughput and in block 270, the TCP processing mode can be set to NIC in order to provide greater scalability. Notably, the selection of the interval can account for the overhead of copying the TCP connection data back and forth from the network adapter and the host process in order to accommodate dynamic switching of NIC and TOE modes.

In any case, subsequent to the selection of the interval, in block 280 the next interval, now the duration of the throughput, can proceed and in block 290, the current throughput can be retrieved. In decision block 300, if the current throughput does not exceed the interval, in block 320 the threshold can be modified to the observed block size. Otherwise, the mode can be reset to TOE and the process can repeat through block 250.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In transport control protocol (TCP)/Internet protocol (IP) based inter-process communications, a method of selectively accelerating TCP connections comprising:
establishing a TCP connection for TCP/IP inter-process communications;
observing a block size for the TCP connection; and,
switching between TCP/IP processing in a host processor and TCP/IP processing in a TCP offload engine (TOE) in a network adapter coupled to the host processor based upon the observed block size exceeding a threshold value.

2. The method of claim 1, wherein observing a block size for the TCP connection, comprises measuring an average block size for the TCP connection of a particular interval of time.

3. The method of claim 2, further comprising adjusting the interval of time to account for latencies associated with moving connection state data between the host processor and the network adapter during switching.

4. The method of claim 1, wherein switching between TCP/IP processing in a host processor and TCP/IP processing in a TOE in a network adapter coupled to the host processor based upon the observed block size exceeding a threshold value, comprises switching from TCP/IP processing in a host processor to TCP/IP processing in a TOE when the observed block size exceeds a threshold value.

5. The method of claim 4, wherein switching between TCP/IP processing in a host processor and TCP/IP processing in a TOE in a network adapter coupled to the host processor based upon the observed block size exceeding a threshold value, further comprises switching from TCP/IP processing in a TOE to TCP/IP processing in a host processor when the observed block size falls below a threshold value.

6. A transport control protocol (TCP)/Internet protocol (IP) based inter-process communications data processing system comprising:
a host processor disposed in a host computing platform;
a network adapter coupled to the host computing platform, the network adapter comprising a TCP offload engine (TOE); and,
a shim layer disposed in the host processor, the shim layer comprising program code enabled to observe a block size for a supported TCP connection and switch between TCP/IP processing in the host processor and TCP/IP processing in the TOE based upon the observed block size exceeding a threshold value.

7. The system of claim 6, wherein the network adapter is a network interface card (NIC).

8. A computer program product comprising a computer usable medium embodying computer usable program code for selectively accelerating transport control protocol (TCP) connections in TCP/Internet protocol (IP) based inter-process communications, the computer program product including:
computer usable program code for establishing a TCP connection for TCP/IP inter-process communications;
computer usable program code for observing a block size for the TCP connection; and,
computer usable program code for switching between TCP/IP processing in a host processor and TCP/IP processing in a TCP offload engine (TOE) in a network adapter coupled to the host processor based upon the observed block size exceeding a threshold value.

9. The computer program product of claim 8, wherein the computer usable program code for observing a block size for the TCP connection, comprises computer usable program code for measuring an average block size for the TCP connection of a particular interval of time.

10. The computer program product of claim 9, further comprising computer usable program code for adjusting the interval of time to account for latencies associated with moving connection state data between the host processor and the network adapter during switching.

11. The computer program product of claim 8, wherein the computer usable program code for switching between TCP/IP processing in a host processor and TCP/IP processing in a TOE in a network adapter coupled to the host processor based upon the observed block size exceeding a threshold value, comprises computer usable program code for switching from TCP/IP processing in a host processor to TCP/IP processing in a TOE when the observed block size exceeds a threshold value.

12. The computer program product of claim 11, wherein the computer usable program code for switching between TCP/IP processing in a host processor and TCP/IP processing in a TOE in a network adapter coupled to the host processor based upon the observed block size exceeding a threshold value, further comprises computer usable program code for switching from TCP/IP processing in a TOE to TCP/IP processing in a host processor when the observed block size falls below a threshold value.
